(19) United States
(12) Patent Application Publication
(10) Pub. No.: US 2024/0202311 A1
(43) Pub. Date: Jun. 20, 2024

(54) Password Generation and Verification Method and System

(71) Applicant: FLYTECH TECHNOLOGY CO., LTD., Taipei City (TW)

(72) Inventors: Ho-Hsiung HSU, Taipei City (TW); I-Shin MA, Taipei City (TW)

(21) Appl. No.: 18/133,596

(22) Filed: Apr. 12, 2023

(30) Foreign Application Priority Data
Dec. 20, 2022 (TW) 111149034

(51) Int. Cl. G06F 21/46

(52) U.S. Cl. CPC G06F 21/46

(57) ABSTRACT

The present invention relates to a password generation and verification method. The method includes: in a user end verifier device, randomly generating and displaying a prompt message in response to a login request from a user; receiving a password inputted by the user based on the prompt message via the user end verifier device; transmitting the prompt message and the password from the user end verifier device to a remote end verifier device in response to the input of the password; in the remote end verifier device, executing a second verifier programming module to generate a second verification code in accordance with at least one predetermined password generation rule that is preselected by the user; and accepting the login request, when the password matches the second verification code.

### CROSS-REFERENCE TO RELATED APPLICATION

This application claims priority benefit to Taiwan Invention Patent Application Serial No. 111149034, filed on Dec. 20, 2022, in Taiwan Intellectual Property Office, the entire disclosures of which are incorporated by reference herein.

### FIELD

The present invention relates to a password generation and verification method and system, in particular to a password generation and verification method and system based on a dynamic random password generation technology.

### BACKGROUND

In modern daily life, the protection for a variety of information systems by using password settings has always been the basic but effective means of maintaining cyber security, to ensure that sensitive and economically valuable information is duly accessed and properly used by the correctly authorized owner.

There are two types of passwords: static passwords and dynamic passwords. A static password is the simplest fixed password that remains fixed and unchanged unless the user actively changes it. However, it is easy to steal by implanting Trojan horse and keylogger programs. A dynamic password is also known as a one-time password. Each time when a user logs on, the system dynamically generates a temporary password. After authentication by the server, the temporary password is erased. A new password is reissued, when the next time the user logs on. The dynamic password is usually considered a type of relatively secure password.

Therefore, many information security defense measures have been developed based on the concept of dynamic passwords in an attempt to enhance information security protection, such as Public Key Infrastructure (PKI), HTTPS based on SSL/TLS, Key Distribution Center (KDC), Multi-Factor Authentication (MFA), Single Sign-On (SSO) mechanisms, etc.

Nevertheless, the major issue with dynamic password technology is that there are many limitations on how a text messaging containing password can be receive. For example, if the telecommunications signal is weak, the user may not be able to receive the password text messaging, or the password text message may be received over time, resulting in the failure to log in to the system and other problems. In addition, many dynamic password technologies claim to provide better degree of protection and allow for the ceration of simple password. However, simple passwords are easily to be cracked instead. The above-mentioned problems must be overcome.

Hence, there is a need to solve the above deficiencies/issues.

### SUMMARY

The present invention relates to a password generation and verification method and system, in particular to a password generation and verification method and system based on a random dynamic password generation technology.

Accordingly, the present invention provides a password generation and verification method. The method includes: in a user end verifier device, randomly generating and displaying a prompt message in response to a login request from a user; receiving a password inputted by the user based on the prompt message via the user end verifier device; transmitting the prompt message and the password from the user end verifier device to a remote end verifier device in response to the input of the password; in the remote end verifier device, executing a second verifier programming module to generate a second verification code in accordance with at least one predetermined password generation rule that is preselected by the user; and accepting the login request, when the password matches the second verification code.

The present invention further provides a password generation and verification system. The system includes: a user end verifier device and a remote end verifier device communicatively connected with each other through a network and configured to execute processes as follows: in the user end verifier device, randomly generating and displaying a prompt message in response to a login request from a user; receiving a password inputted by the user based on the prompt message via the user end verifier device; transmitting the prompt message and the password from the user end verifier device to the remote end verifier device in response to the input of the password; in the remote end verifier device, executing a second verifier programming module to generate a second verification code in accordance with at least one predetermined password generation rule that is preselected by the user; and accepting the login request, when the password matches the second verification code.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation according to the present invention and many of the attendant advantages thereof are readily obtained as the same become better understood by reference to the following detailed description when considered in connection with the accompanying drawing, wherein:

FIG. 1 is a schematic diagram illustrating the system architecture for the password generation and verification system according to the present invention;

FIG. 2 is a schematic diagram illustrating the hardware architecture for the user end verifier device according to the present invention;

FIG. 3 is a schematic diagram illustrating the hardware architecture of the remote end verifier device according to the present invention;

FIG. 4 is a schematic diagram illustrating the password prompt message displayed on the login page in the first embodiment for the password generation and verification method according to the present invention;

FIG. 5 is a schematic diagram illustrating the password prompt message displayed on the login page in the second embodiment for the password generation and verification method according to the present invention; and

FIG. 6 is a flow chart showing the steps for implementing the password generation and verification method according to the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice. It is clear that other embodiments can be configured according to the knowledge of persons skilled in the art without departing from the true technical teaching of the present disclosure, the claimed disclosure being limited only by the terms of the appended claims.

It is to be noticed that the term “including,” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

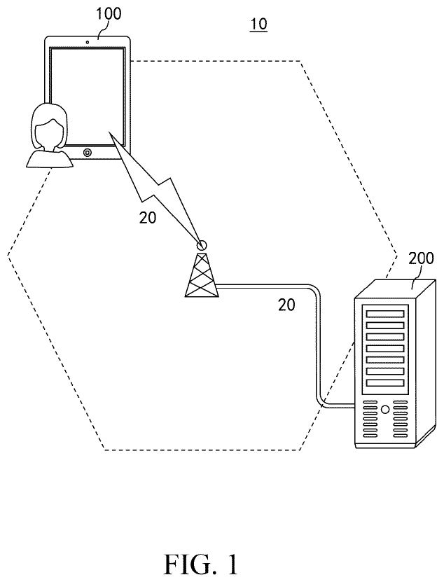

FIG. 1 is a schematic diagram illustrating the system architecture for the password generation and verification system according to the present invention. The password generation and verification system 10 according to the present invention includes a user end verifier device 100 and a remote end verifier device 200, which are communicatively connected to each other through a network 20. Preferably the network 20 extensively includes the Internet, a wide-area network (WAN), a local area network (LAN), a wired network, a wireless network, a telecommunications network, or a combination thereof. The password generation and verification system 10 is preferably configured to implement the password generation and verification method according to the present invention.

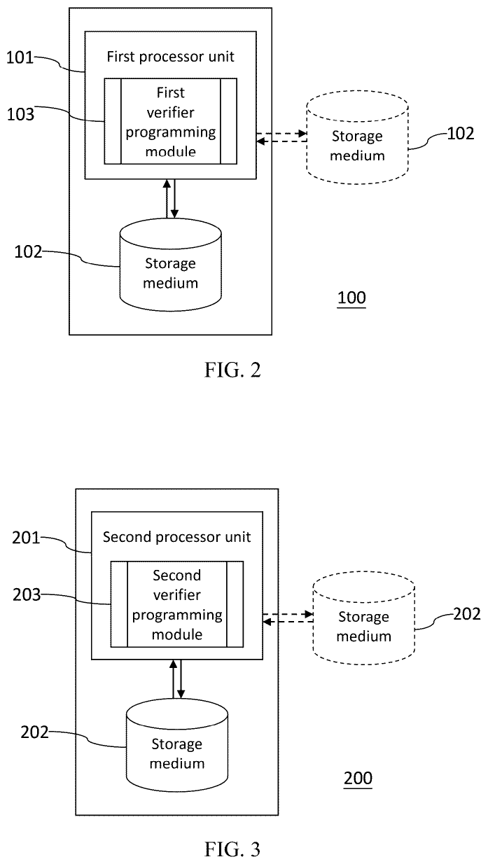

FIG. 2 is a schematic diagram illustrating the hardware architecture for the user end verifier device according to the present invention. The user end verifier device 100 included in the present invention is preferably a user equipment operated and used by a user, covering but is not limited to a desktop computer, a notebook computer, a smart phone, a tablet device, or a mobile device, and so on. Regardless of the type to which the user equipment belongs, its hardware structure includes at least a first processor unit 101 and at least a storage medium 102. The storage medium 102 is preferably a local storage medium installed inside the user end verifier device 100, or an external storage medium connected externally, as shown in FIG. 2.

The first processor unit 101 is configured to load and execute a plurality of processor-executable programming modules. These programming modules are pre-stored on the storage medium 102 and executed by the first processor unit 101 after being loaded into the first processor unit 101. These programming modules include but are not limited to a first verifier programming module 103.

FIG. 3 is a schematic diagram illustrating the hardware architecture of the remote end verifier device according to the present invention. The remote end verifier device 200 included in the present invention is preferably a remote server or preferably includes a plurality of remote servers. For example, the remote end verifier device 200 is preferably, but is not limited to an application server, a web server, a mail server, a database server, a file server, etc. Regardless of the type of server, its hardware structure includes at least one second processor unit 201 and at least one storage medium 202. The storage medium 202 is preferably a local storage medium installed inside the remote end verifier device 200, or an external storage medium connected externally, as shown in FIG. 3.

The second processor unit 201 is configured to load and execute a plurality of processor-executable programming modules. These programming modules are pre-stored on the storage medium 202 and are executed by the second processor unit 201 after being loaded into the second processor unit 201. These programming modules include but are not limited to a second verifier programming module 203.

The present invention provides for any user to self-create multiple rules for generating a password. Each password generation rule is like a virtual converter that converts a meaningful or meaningless password prompt message into a single digit or numbers, and thus a password prompt message is converted into a set of digital passwords by combining the analyses resulting from multiple password generation rules. The password prompt message is preferably any random combination of numbers, words, characters, alphabets, symbols, or icons.

The password generation rules cover at least two different classes of rules, including but not limited to the first-class password generation rule and the second-class password generation rule. Application of the first-class password generation rule generates a first-class password, and application of the second-class password generation rule generates a second-class password.

The purpose of distinguishing the password into different classes is to enable the remote end verifier device 200 to perform the corresponding operation procedure, in response to the input of different classes of passwords generated by a different class of password generation rules. Therefore, the user can enter different classes of passwords in different situations and requirements, to notify the remote end verifier device 200 to activate different operation procedures according to the situations and requirements.

For example, in response to the input of the first-class password, the remote end verifier device 200 executes the first-class operation procedure including, but not limited to, a successful login procedure or a regular operation procedure, and in response to the input of the second-class password, the remote end verifier device 200 executes the second-class operation procedure including, but not limited to, an emergency disposal procedure or an emergency reporting procedure. Thus, when the user encounters a threat to personal safety or an automobile accident, one can decide to input the second-class password, and the remote end verifier device 200 executes the emergency disposal procedure on his behalf.

The password generation rules and the classes of passwords according to the present invention are not limited to two classes. The passwords can be further distinguished into more classes than two classes to provide more types of applications that are not only limited to emergency applications, but are also used to activate other predefined functions or to enter different modes.

For example, the first-class password generation rules are preferably demonstrated as follows:
The first-class password generation rule 1: The total number of numbers or words displayed by the prompt message, and if the total number of numbers or words displayed by the prompt message exceeds 10, the first single digit is taken;
First-class password generation rule 2: The number generated by the previous rule is subtracted by 1 or added by 1 if the number is greater than 5 or less than 5 respectively, leaving the others unchanged;
First-class password generation rule 3: The number generated by the previous rule is subtracted by 1 if the number is odd, leaving the others unchanged;
First-class password generation rule 4: The number generated by the previous rule is added by 3, and the first single digit is taken if decimal digits are generated;
First-class password generation rule 5: The number generated by the previous rule is subtracted by 1 or added by 2 if the number is odd or even respectively, and the first single digit is taken if decimal digits are generated;
First-class password generation rule 6: If the prompt message displays numbers, add the individual numbers one by one, and the first single digit is taken if the total sum produces decimal digits; if the prompt message displays any words and the total number of numbers and words exceeds 10, the first single digit is taken;
First-class password generation rule 7: The number generated by the previous rule is subtracted by 5 or added by 2 if the number is greater than 7 or less than 7 respectively;
First-class password generation rule 8: The number generated by the previous rule is added by 1 or 2, if the prompt message displays words or numbers respectively;
First-class password generation rule 9: The number generated by the previous rule is subtracted by 1 or 2, if the prompt message displays words or numbers respectively and if a negative number is generated, the absolute value is used to generate a positive number;
First-class password generation rule 10: The number generated by the previous rule is multiplied by 2, and the first single digit is taken if decimal digits are generated;
First-class password generation rule 11: The last digit of the number generated by the previous rule is multiplied by 2, and all digits are taken if decimal digits are generated;
First-class password generation rule 12: The last digit of the number generated by the previous rule is added by 2, and all digits are taken if decimal digits are generated; and
First-class password generation rule 13: The last digit of the number generated by the previous rule is added by 7, and all digits are taken if decimal digits are generated.

For example, the second-class password generation rules are preferably demonstrated as follows:
The second-class password generation rule 1: If the number of passwords generated by the password generation rules is the same as the number of numbers or words displayed by the password prompt message, the last digit of the first-class password is changed to the 10's complement, and for example, the 10's complement number of 2 is 8; If the last digit is 0, it is changed to 5 and if the last digit is 5, it is changed to 0; and
Second-class password generation rule 2: If the number of passwords generated by the password generation rules is different from the number of numbers or words displayed by the password prompt message, 95 is added to the end of the normal first-class password.

The setting of the first- and second-class password generation rules is not only limited to the mathematical calculation formula, but also extensively based on such as the date, week, time, and so on. The password generation rules must satisfy requirements such as being logical, unique, and program computable.

Any user may predefine a large number of first- and second-class password generation rules without limitation, and then assemble these password generation rules to form a password generation rule database. Users may freely add any new password generation rule, and edit, modify, or delete any existing first- and second-class password generation rules in the password generation rule database.

After the password generation rule database is built, the user preselects and determines a plurality of first and second class password generation rules from the password generation rule database as the predetermined password generation rules. The first verifier programming module 103 and the second verifier programming module 203 are formed according to the preselected password generation rules. The first verifier programming module 103 includes a plurality of password generation rules preselected by the user, as well as the second verifier programming module 203 includes a plurality of password generation rules preselected by the user.

When the user end verifier device 100 loads and executes the first verifier programming module 103 in the first processor unit 101, it is equivalent to executing multiple predetermined password generation rules. When the remote end verifier device 200 loads and executes the second verifier programming module 203 in the second processor unit 201, it is equivalent to executing multiple predetermined password generation rules.

After the user end verifier device 100 executes the first verifier programming module 103, the password prompt message is converted into the first verification code according to the multiple predetermined password generation rules. After the remote end verifier device 200 executes the second verifier programming module 203, the password prompt message is converted into a second verification code according to the multiple predetermined password generation rules.

### The First Embodiment

In the first embodiment according to the present invention, the Internet application service provided in the form of a PaaS-based application is illustrated as an example of the password generation and verification method according to the present invention. The Internet application service is a type of network application service that combines the application program interface and the user interface, runs in the seventh layer of the Open System Interconnection (OSI) model, and provides a variety of application services via the user interface by such as Internet browser over the network. The Internet application service is also referred to as an application service.

In this embodiment, the application service is implemented at the user end by providing a front-end application program as a user interface which the front-end application program runs on the user equipment and connects to the backend platform. The user end verifier device 100 is preferably a smartphone. The front-end application program is preferably such as a bank App, a securities App, a telecommunication App, etc. The remote end verifier device 200, which is practically installed with the back-end platform capable of providing application services, is preferably a single server or multiple application servers.

In this embodiment, each time the user enters the login page provided by the application service, the system detects that the user has made a login request to the application service. When the user end verifier device 100 receives the login request from the user, the first processor unit 101 is configured to randomly generate a password prompt message and display the password prompt message on the login page.

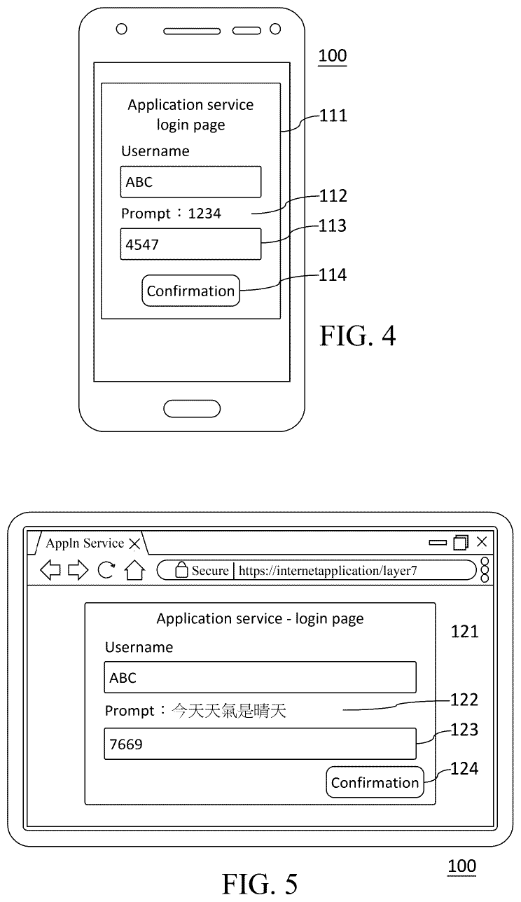

FIG. 4 is a schematic diagram illustrating the password prompt message displayed on the login page in the first embodiment for the password generation and verification method according to the present invention. In this embodiment, the user has preselected the first-class password generation rule 1-4 from the password generation rule database as the predetermined password generation rule. Thus, the first verifier programming module 103 and the second verifier programming module 203 is preconfigured to contain the first-class password generation rule 1-4.

When the user enters the login page 111 provided by the application service, the password prompt message randomly generated by the user end verifier device 100 is “1234”, and the password prompt message containing number of “1234” is displayed in the corresponding password prompt message column 112 on the login page.

According to the first-class password generation rule 1, since the password prompt message contains a number with a total of 4 digits, the first-place password generated by the first-class password generation rule 1 should be 4. According to the first-class password generation rule 2, since the password generated by the previous rule, the first-class password generation rule 1, is less than 5, the first-place password is added by 1, and the generated second-place password is 5. According to the first-class password generation rule 3, since the password generated by the first-class password generation rule 2 is an odd number, the second-place password is subtracted by 1, and the generated third-place password is 4. According to the first-class password generation rule 4, the third-place password generated by the first-class password generation rule 3 is added by 3. The generated fourth-place password is 7, and there is none of decimal digit generated.

If the user correctly analyzes or decodes the password prompt message according to the first-class password generation rules 1-4 pre-set by the user, the obtained first-class password should be 4547. The user then enters the password 4547 into the corresponding password entry column 113 on the login page 111 and presses the confirmation button 114 to determine the entered password to the system. As soon as the user presses the confirmation button 114, the system considers the input of the passwords to be confirmed.

In response to the confirmation for inputting the password, if the network 20 is available, the user end verifier device 100 immediately transmits a login request and the password prompt message to the remote end verifier device 200. After the remote end verifier device 200 acknowledges receipt of the login request and the password prompt message, the second verifier programming module 203 is loaded in and executed by the second processor unit 202 to perform the first class password generation rules 1-4. The password prompt message is decoded to generate the second verification code. The second verification code is preferably 4547.

Next, the remote end verifier device 200 verifies whether the password entered by the user into the second processor unit 202 matches the second verification code decoded by the second processor unit 202. If the password matches the second verification code and it is determined that the password complies with the first class password generation rules, the remote end verifier device 200 performs a successful login procedure or a regular operation procedure, accepts or allows the user to log in to the application service, and returns a successful login message to the user end verifier device 100.

After sending the successful login message, the remote end verifier device 200 permanently deletes the password prompt message and the second verification code. After receiving the successful login response, the user end verifier device 100 allows the user to log in to the remote end verifier device 200 via the user end verifier device 100 to start using the application service and permanently deletes the password prompt message, the password, and the first verification code.

If the second processor unit 202 in the remote end verifier device 200 determines that the password entered by the user into the second processor unit 202 does not match the decoded second verification code, the remote end verifier device 200 executes the login failure procedure, rejects the login request to the application service, then returns a login failure message to the user end verifier device 100, and permanently deletes the password prompt message, the password, and the first verification code.

If the network 20 is unavailable, the user end verifier device 100 fails to send the login request and the password prompt message to the remote end verifier device 200 and receives a response of transmission failure. In response to the confirmation of the input of the password, the first verifier programming module 103 is loaded in and executed by the first processor unit 101 in the user end verifier device 100 to perform the first-class password generation rules 1-4. The password prompt message is decoded to generate the first verification code. The first verification code is preferably 4547.

Next, the user end verifier device 100 verifies whether the password entered by the user into the first processor unit 101 matches the first verification code decoded by the first processor unit 101. If the password matches the first verification code and it is determined that the password complies with the first class password generation rules, the user is allowed to access the backend platform to use the application services through the user end verifier device 100. However, since the network 20 is unavailable, the user end verifier device 100 continues to send access request messages to the remote end verifier device 200.

If the user end verifier device 100 repeatedly receives the response of transmission failure for a period of time, the user end verifier device 100 terminates the current login operation procedure, and permanently deletes the password prompt message, the password, and the first verification code.

The password generation and verification method according to the present invention is configured to generate different prompt messages each time the user logs in. Therefore, the user is required to enter different passwords each time the user logs in, which effectively enhances the security of password usage and has the characteristics of a one-time password. It can avoid the risk of not receiving message notifications or connection timeout when the network is unavailable, such as weak network signal.

### The Second Embodiment

In the second embodiment, the password generation and verification method according to the present invention is demonstrated and implemented by the network application service provided in the SaaS form based on a web page loaded by a browser. The second embodiment is based on the first embodiment and includes the first embodiment.

In the second embodiment, the user end verifier device 100 is preferably a notebook computer. The application service is preferably an Internet based service provided through an Internet browser, such as a Gmail service, a bank network ATM service, etc. The remote end verifier device 200 is preferably one or more mail servers or one or more application servers. In this embodiment, the e-mail service uses a browser running on a notebook computer as the front-end user interface, while the corresponding mail server that executes the application service program acts as a backend platform.

FIG. 5 is a schematic diagram illustrating the password prompt message displayed on the login page in the second embodiment for the password generation and verification method according to the present invention. In this embodiment, the user preselects the first-class password generation rules 1-4 from the password generation rule database as the predetermined password generation rules to form the first verifier programming module 103 and the second verifier programming module 203 accordingly. The first verifier programming module 103 and the second verifier programming module 203 both contain the first-class password generation rules 1-4.

When the user enters the login page 121 provided by the application service, the password prompt message randomly generated by the user end verifier device 100 displays “ [symbol] ” in Chinese characters, which means “the weather is sunny today”. The password prompt message of “ [symbol] ” is displayed on the login page 121 in the corresponding password prompt message column 122.

According to the first-class password generation rule 1, since the password prompt message has a total of 7 characters, the first-place password generated by the first-class password generation rule 1 should be 7. According to the first-class password generation rule 2, since the password generated by the first-class password generation rule 1 is greater than 5, the first-place password is subtracted by 1, and the generated second-place password is 6. According to the first-class password generation rule 3, since the password generated by the first-class password generation rule 2 is not an odd number, the second-place password does not need to be changed, and the generated third-place password is 6. According to the first-class password generation rule 4, the third-place password generated by the first-class password generation rule 3 is added by 3, the generated fourth-place password is 9, and there is none of decimal digit generated.

If the user correctly analyzes or decodes the password prompt message according to the first-class password generation rules 1-4 pre-set by the user, the password of 7669 should be obtained. The user then enters 7669 into the corresponding password entry column 123 on the login page 121 and presses the confirmation button 124.

If the network 20 is available, after the remote end verifier device 200 acknowledges receipt of the password prompt message, the second verifier programming module 203 is loaded into and executed by the second processor unit 202 to perform the first-class password generation rules 1-4 to decode the password prompt message and generate a second verification code of 7669. The remote end verifier device 200 verifies whether the password entered by the user matches the second verification code in the second processor unit 202. If the password matches the second verification code, the remote end verifier device 200 performs the first-class operation procedure and returns a successful login message to the user end verifier device 100.

### The Third Embodiment

In the third embodiment, the user preselects the first-class password generation rules 1, 3, 5, and 7 as the predetermined password generation rules, and the password prompt message randomly generated by the user end verifier device 100 displays “ [symbol] ” in Chinese characters. The third embodiment is based on the first embodiment and includes the first embodiment.

According to the first-class password generation rule 1, since the password prompt message has 7 characters in total, the generated first-place password should be 7 because it has 7 characters. According to the first-class password generation rule 3, since the number 7 generated by the first-class password generation rule 1 is an odd number, the first-place password is subtracted by 1, and the generated second-place password is 6. According to the first-class password generation rule 5, since the second-place password 6 generated by the first-class password generation rule 3 is an even number, the second-place password is added by 2, and the generated third-place password is 8. According to the first-class password generation rule 7, since the third-place password 8 generated by the first-class password generation rule 5 is greater than or equal to 7, the third-place password is subtracted by 5, and the generated fourth-place password is 3.

If the user correctly analyzes or decodes the password prompt message according to the first-class password generation rules 1, 3, 5, and 7 pre-set by the user, the obtained password should be 7683. The second verification code generated by the remote end verifier device 200 after the second processor unit 202 executes the second verifier programming module 203 should also be 7683.

### The Fourth Embodiment

In the fourth embodiment, the predetermined password generation rules are the first-class password generation rules 6, 7, 10, and 4, and the password prompt message randomly generated by the user end verifier device 100 displays “1234” in Arabic numerals. The fourth embodiment is based on the first embodiment and includes the first embodiment.

According to the first-class password generation rule 6, if the prompt message displays numbers, the numbers are added together one by one. If the total sum produces decimal digits, the first single digit is taken. Thus, since the prompt message displays numbers and the total sum is 10, the first single digit is taken and the generated first-place password is 0 correspondingly. According to the first-class password generation rule 7, the number generated by the previous rule, the first-class password generation rule 6, is subtracted by 5 or added by 2 if the number is greater than or equal to 7 or less than 7. Since 0 is less than 7, the first-place password is added by 2 and the generated second-place password is 2. According to the first-class password generation rule 10, the number generated by the first-class password generation rule 7 is multiplied by 2, and if any decimal digit is generated the first single digit is taken. Therefore, the second-place password 2 is multiplied by 2 to generate the third-place password of 4. According to the first-class password generation rule 4, the number generated by the first-class password generation rule 10 is added by 3, and the generated fourth-place password is 7.

If the user correctly analyzes or decodes the password prompt message according to the first-class password generation rules 6, 7, 10, and 4 pre-set by the user, the obtained password should be 0247. The second verification code generated by the remote end verifier device 200 after the second processor unit 202 executes the second verifier programming module 203 should also be 0247.

### The Fifth Embodiment

In the fifth embodiment, the predetermined password generation rules are the first-class password generation rules 1, 2, 11, and 12, and the password prompt message randomly generated by the user end verifier device 100 displays “ [symbol] [symbol] ”. The fifth embodiment is based on the first embodiment and includes the first embodiment.

According to the first-class password generation rule 1, if the total number of numbers or words displayed by the prompt message exceeds 10, the first single digit is taken. Since the prompt message displays a total of 7 characters, the first-place password is 7. According to the first-class password generation rule 2, if the number generated by the previous rule is greater than 5, it is subtracted by 1. Since 7 is greater than 5, it is subtracted by 1, so the second-place password is 6. According to the first-class password generation rule 11, the last number generated by the previous rule is multiplied by 2, and if decimal digits are generated, all digits are taken. Since 6 times 2 is equal to 12, the third-place password is 12 correspondingly. According to the first-class password generation rule 12, 2 is added to the last digit generated by the previous rule. Since the third-place password is 12 and the last digit is 2, the fourth-place password is 4.

If the user correctly analyzes or decodes the password prompt message according to the first-class password generation rules 1, 2, 11, and 12 pre-set by the user, the obtained password should be 76124. The second verification code generated by the remote end verifier device 200 after the second processor unit 202 executes the second verifier programming module 203 should also be 76124.

### The Sixth Embodiment

In the sixth embodiment, the predetermined password generation rules are the first-class password generation rules 1, 12, 13, and 11, and the password prompt message randomly generated by the user end verifier device 100 displays “1234”. The sixth embodiment is based on the first embodiment and includes the first embodiment.

According to the first-class password generation rule 1, the total number of numbers or words displayed by the prompt message should be the password. Since there are totally 4 numbers, the first-place password is 4. According to the first-class password generation rule 12, the last digit of the number generated by the previous rule is added by 2, and all digits are taken if decimal digits are generated. Then, 4 plus 2 equals 6, and the resulting password is 6. According to the first-class password generation rule 13, the last digit of the number generated by the previous rule is added by 7, and all digits are taken if decimal digits are generated. Since 6 plus 7 is equal to 13, the resulting password is 13. According to the first-class password generation rule 11, the last digit generated by the previous rule is multiplied by 2, and if decimal digits are generated, all digits are taken. Since 3 times 2 is equal to 6, the resulting password is 6.

If the user correctly analyzes or decodes the password prompt message according to the first-class password generation rules 1, 12, 13, and 11 pre-set by the user, the obtained password should be 46136. The second verification code generated by the remote end verifier device 200 after the second processor unit 202 executes the second verifier programming module 203 should also be 46136.

### The Seventh Embodiment

In the seventh embodiment, the predetermined password generation rules are the first-class password generation rules 1, 3, 5, 7, and the second-class password generation rule 1. The password prompt message randomly generated by the user end verifier device 100 displays “ [symbol] ”. The seventh embodiment is based on the first embodiment and the third embodiment and includes the first embodiment and the third embodiment. When the user applies the first-class password generation rules 1, 3, 5, and 7 to correctly analyze or decode the password prompt message, the first-class password of 7683 is obtained, as described in the third embodiment.

However, if the user encounters an emergency, such as under duress, the user may switch to analyzing or decoding the password prompt message by the first-class password generation rules 1, 3, 5, and 7 in conjunction with the second-class password generation rule 1. According to the second-class password generation rule 1, since the number of passwords generated by the password generation rules is the same as the number of numbers or words displayed by the password prompt message, the last digit of the first-class password 7683 that is obtained by the first-class password generation rules 1, 3, 5, and 7 is 3, and the 10's complement of 3 is 7, the resulting second-class password is 7687.

If the user correctly analyzes or decodes the password prompt message according to the first-class password generation rules 1, 3, 5, 7 and the second-class password generation rule 1 pre-set by the user, the second-class password of 7687 is supposed to be obtained. The second verification code generated by the remote end verifier device 200 after the second processor unit 202 executes the second verifier programming module 203 should also be 7687.

When the remote end verifier device 200 confirms that the password entered by the user is correct and determines that it is the second-class password that complies with the second-class password generation rule 1, the remote end verifier device 200 not only executes the first-class operation procedure, such as the successful login procedure, but also executes the second-class operation procedures, such as the emergency disposal procedure or the emergency reporting procedure, at the same time.

### The Eighth Embodiment

In the eighth embodiment, the predetermined password generation rules include the first-class password generation rules 1, 12, 13, and 11, and the second-class password generation rule 2. The password prompt message randomly generated by the user end verifier device 100 displays “1234”. The eighth embodiment is based on the first embodiment and the sixth embodiment and includes the first embodiment and the sixth embodiment.

When the user applies the first-class password generation rules 1, 3, 5, and 7 to correctly analyze or decode the password prompt message, the first-class password of 46136 is obtained, as described in the sixth embodiment. However, when the user encounters an emergency, such as a car accident, the user may switch to analyzing or decoding the password prompt message by the first-class password generation rules 1, 3, 5, and 7 in conjunction with the second-class password generation rule 2. According to the second-class password generation rule 2, the second-class password of 4613695 is obtained by adding 95 to the end of the first-class password.

When the remote end verifier device 200 confirms that the password entered by the user is correct and determines that it is the second-class password that complies with the second-class password generation rule 1, the remote end verifier device 200 not only executes the first-class operation procedure, such as the successful login procedure, but also simultaneously executes the second-class operation procedures, such as the emergency reporting procedure, to report the current location of the user end verifier device 100 to the police.

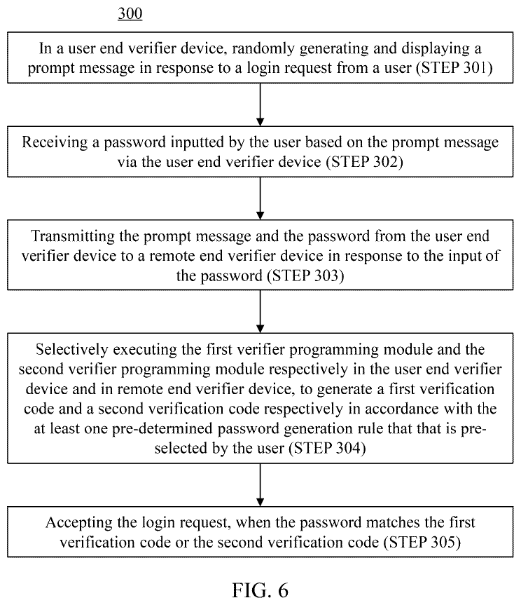

FIG. 6 is a flow chart showing the steps for implementing the password generation and verification method according to the present invention. The password generation and verification method 300 according to the present invention preferably includes, but is not limited to, the following steps performed by the processor unit: in a user end verifier device, randomly generating and displaying a prompt message in response to a login request from a user (STEP 301); receiving a password inputted by the user based on the prompt message via the user end verifier device (STEP 302); transmitting the prompt message and the password from the user end verifier device to a remote end verifier device in response to the input of the password (STEP 303); selectively executing the first verifier programming module and the second verifier programming module respectively in the user end verifier device, to generate a first verification code and a second verification code respectively in accordance with the at least one predetermined password generation rule that that is preselected by the user (STEP 304); and accepting the login request, when the password matches the first verification code or the second verification code (STEP 305).

The method according to the present invention aims to change the traditional setting of the password to the setting of the password generation rule to randomly generate a set of password prompt message on the login page. Then, the user recovers the correct password according to the prompt message and the pre-set, preselected or predetermined password generation rules and enters it into the login page. Thus, based on the feature of random generation of the prompt message, the password entered by the user is different every time, so that the password has the characteristics of a one-time password. It also avoids the problem of not receiving message notifications or receiving the notification over time when the telecommunication signal is weak.

There are further embodiments provided as follows.

Embodiment 1: A password generation and verification method includes: in a user end verifier device, randomly generating and displaying a prompt message in response to a login request from a user; receiving a password inputted by the user based on the prompt message via the user end verifier device; transmitting the prompt message and the password from the user end verifier device to a remote end verifier device in response to the input of the password; in the remote end verifier device, executing a second verifier programming module to generate a second verification code in accordance with at least one predetermined password generation rule that is preselected by the user; in the remote end verifier device, determining whether the password complies with at least one first-class password generation rule and executing a first-class operation procedure when the password complies with the at least one first-class password generation rule; and in the remote end verifier device, determining whether the password complies with at least one second-class password generation rule and executing a second-class operation procedure when the password complies with the at least one second-class password generation rule.

Embodiment 2: The password generation and verification method as described in Embodiment 1, further includes one of: providing a password generation rule database which comprises one of the at least one first-class password generation rule and the at least one second-class password generation rule; selecting one of the at least one first-class password generation rule and the at least one second-class password generation rule out of the password generation rule database as the at least one predetermined password generation rule; interpreting the prompt message into the password in accordance with the at least one predetermined password generation rule; in the user end verifier device, randomly generating and displaying the prompt message in response to the login request from the user and showing the prompt message in a login page; configuring a first verifier programming module in the user end verifier device and the second verifier programming module in the remote end verifier device, wherein the first verifier programming module and the second verifier programming module comprise the at least one predetermined password generation rule; selectively executing the first verifier programming module in the user end verifier device to generate a first verification code in accordance with the at least one predetermined password generation rule that that is preselected by the user; loading in and executing the first verifier programming module by a first processor unit comprised in the user end verifier device to generate the first verification code; loading in and executing the second verifier programming module by a second processor unit comprised in the remote end verifier device to generate a second verification code; accepting the login request, when the password matches the first verification code or the second verification code; rejecting the login request, when the password does not match the first verification code; and rejecting the login request, when the password does not match the second verification code.

Embodiment 3: The password generation and verification method as described in Embodiment 1, further includes one of: accepting the login request when the remote end verifier device determines that the password matches the second verification code; and sending a successful login message from the remote end verifier device to the user end verifier device, when the password matches the second verification code.

Embodiment 4: The password generation and verification method as described in Embodiment 2, further includes one of: deleting the prompt message, the password and the first verification code in the user end verifier device permanently, when the user end verifier device receives the successful login message; and deleting the prompt message, the password and the second verification code in the remote end verifier device permanently, when the successful login message is sent out from the remote end verifier device.

Embodiment 5: The password generation and verification method as described in Embodiment 1, the at least one predetermined password generation rule comprises one of the at least one first-class password generation rule and the at least one second-class password generation rule.

Embodiment 6: The password generation and verification method as described in Embodiment 1, the first-class operation procedure is one selected from a successful login procedure and a regular operation procedure, and the second-class operation procedure is one selected from an emergency disposal procedure and an emergency reporting procedure.

Embodiment 7: The password generation and verification method as described in Embodiment 1, the at least one first-class password generation rule and the at least one second-class password generation rule are used for transforming the prompt message into a single digit or a single number.

Embodiment 8: The password generation and verification method as described in Embodiment 1, the prompt message comprises one of a digit, a number, a word, a character, an alphabet, a symbol, an icon and a combination thereof.

Embodiment 9: The password generation and verification method as described in Embodiment 1, the user end verifier device is selected from one of a user equipment, a desktop computer, a personal computer, a notebook computer, a smart phone, a table device and a mobile device, and the remote end verifier device is selected from one of an application server, a web server, a mail server, a data server and a file server.

Embodiment 10: A password generation and verification system includes: a user end verifier device and a remote end verifier device communicatively connected with each other through a network and configured to execute processes as follows: in the user end verifier device, randomly generating and displaying a prompt message in response to a login request from a user; receiving a password inputted by the user based on the prompt message via the user end verifier device; transmitting the prompt message and the password from the user end verifier device to the remote end verifier device in response to the input of the password; in the remote end verifier device, executing a second verifier programming module to generate a second verification code in accordance with at least one predetermined password generation rule that is preselected by the user; in the remote end verifier device, determining whether the password complies with at least one first-class password generation rule and executing a first-class operation procedure when the password complies with the at least one first-class password generation rule; and in the remote end verifier device, determining whether the password complies with at least one second-class password generation rule and executing a second-class operation procedure when the password complies with the at least one second-class password generation rule.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A password generation and verification method, comprising:
in a user end verifier device, randomly generating and displaying a prompt message in response to a login request from a user;
receiving a password inputted by the user based on the prompt message via the user end verifier device;
transmitting the prompt message and the password from the user end verifier device to a remote end verifier device in response to the input of the password;
in the remote end verifier device, executing a second verifier programming module to generate a second verification code in accordance with at least one predetermined password generation rule that is preselected by the user;
in the remote end verifier device, determining whether the password complies with at least one first-class password generation rule and executing a first-class operation procedure when the password complies with the at least one first-class password generation rule; and
in the remote end verifier device, determining whether the password complies with at least one second-class password generation rule and executing a second-class operation procedure when the password complies with the at least one second-class password generation rule.

2. The password generation and verification method as claimed in claim 1, further comprising one of:
providing a password generation rule database which comprises one of the at least one first-class password generation rule and the at least one second-class password generation rule;
selecting one of the at least one first-class password generation rule and the at least one second-class password generation rule out of the password generation rule database as the at least one predetermined password generation rule;
interpreting the prompt message into the password in accordance with the at least one predetermined password generation rule;
in the user end verifier device, randomly generating and displaying the prompt message in response to the login request from the user and showing the prompt message in a login page;
configuring a first verifier programming module in the user end verifier device and the second verifier programming module in the remote end verifier device, wherein the first verifier programming module and the second verifier programming module comprise the at least one predetermined password generation rule;
selectively executing the first verifier programming module in the user end verifier device to generate a first verification code in accordance with the at least one predetermined password generation rule that that is preselected by the user;
loading in and executing the first verifier programming module by a first processor unit comprised in the user end verifier device to generate the first verification code;
loading in and executing the second verifier programming module by a second processor unit comprised in the remote end verifier device to generate a second verification code;
accepting the login request, when the password matches the first verification code or the second verification code;
rejecting the login request, when the password does not match the first verification code; and
rejecting the login request, when the password does not match the second verification code.

3. The password generation and verification method as claimed in claim 1, further comprising one of:
accepting the login request when the remote end verifier device determines that the password matches the second verification code; and
sending a successful login message from the remote end verifier device to the user end verifier device, when the password matches the second verification code.

4. The password generation and verification method as claimed in claim 2, further comprising one of:
deleting the prompt message, the password and the first verification code in the user end verifier device permanently, when the user end verifier device receives the successful login message; and
deleting the prompt message, the password and the second verification code in the remote end verifier device permanently, when the successful login message is sent out from the remote end verifier device.

5. The password generation and verification method as claimed in claim 1, wherein the at least one predetermined password generation rule comprises one of the at least one first-class password generation rule and the at least one second-class password generation rule.

6. The password generation and verification method as claimed in claim 1, wherein the first-class operation procedure is one selected from a successful login procedure and a regular operation procedure, and the second-class operation procedure is one selected from an emergency disposal procedure and an emergency reporting procedure.

7. The password generation and verification method as claimed in claim 1, wherein the at least one first-class password generation rule and the at least one second-class password generation rule are used for transforming the prompt message into a single digit or a single number.

8. The password generation and verification method as claimed in claim 1, wherein the prompt message comprises one of a digit, a number, a word, a character, an alphabet, a symbol, an icon and a combination thereof.

9. The password generation and verification method as claimed in claim 1, wherein the user end verifier device is selected from one of a user equipment, a desktop computer, a personal computer, a notebook computer, a smart phone, a table device and a mobile device, and the remote end verifier device is selected from one of an application server, a web server, a mail server, a data server and a file server.

10. A password generation and verification system, comprising:
a user end verifier device and a remote end verifier device communicatively connected with each other through a network and configured to execute processes as follows:
in the user end verifier device, randomly generating and displaying a prompt message in response to a login request from a user;
receiving a password inputted by the user based on the prompt message via the user end verifier device;
transmitting the prompt message and the password from the user end verifier device to the remote end verifier device in response to the input of the password;
in the remote end verifier device, executing a second verifier programming module to generate a second verification code in accordance with at least one predetermined password generation rule that is preselected by the user;
in the remote end verifier device, determining whether the password complies with at least one first-class password generation rule and executing a first-class operation procedure when the password complies with the at least one first-class password generation rule; and
in the remote end verifier device, determining whether the password complies with at least one second-class password generation rule and executing a second-class operation procedure when the password complies with the at least one second-class password generation rule.
